(19) United States
(12) Patent Application Publication
(10) Pub. No.: US 2025/0347127 A1
(43) Pub. Date: Nov. 13, 2025

(54) LOOP TIE FOR CONCRETE FORM PANEL SYSTEMS

(71) Applicant: Titcomb Brothers Manufacturing, Inc., Westport, MA (US)

(72) Inventors: Paul S. TITCOMB, Marion, MA (US); Ted TITCOMB, East Sandwich, MA (US)

(21) Appl. No.: 19/192,056

(22) Filed: Apr. 28, 2025

Related U.S. Application Data
(63) Continuation-in-part of application No. 18/885,036, filed on Sep. 13, 2024.
Application No. 18/885,036 is a continuation of application No. 18/093,622, filed on Jan. 5, 2023, now Pat. No. 12,110,697.
Application No. 18/093,622 is a continuation of application No. 17/164,312, filed on Feb. 1, 2021, now Pat. No. 11,572,701.
Application No. 17/164,312 is a continuation of application No. 16/252,281, filed on Jan. 18, 2019, now Pat. No. 10,907,365.
(60) Provisional application No. 62/619,545, filed on Jan. 19, 2018.
(60) Provisional application No. 63/639,387, filed on Apr. 26, 2024.

(51) Int. Cl. E04G 17/07; B29C 53/56; B29C 70/86; E04G 17/06

(52) U.S. Cl. CPC E04G 17/0721; E04G 17/06; B29C 53/564; B29C 70/86

(57) ABSTRACT

A tie rod suitable for use with known concrete forming systems is constructed from a non-metal fiber, such as fiberglass, that is wound about a pair of opposed thimbles. The resultant tie rod is as strong as a metal tie rod without the drawbacks of conventional metal tie rods. Each of the thimbles has a main body with a channel formed in an outer surface of the main body. The continuous fiber is disposed within the channel when wound thereabout. The continuous fiber is wound to have a depth greater than the thimble in the direction perpendicular to a plane of the thimble.

### RELATED APPLICATIONS

The present application is a continuation-in-part of U.S. Non-Provisional application Ser. No. 18/885,036, filed Sep. 13, 2024, and entitled LOOP TIE FOR CONCRETE FORMING PANEL SYSTEMS. The present application also claims benefit of Provisional Application No. 63/639,387 entitled LOOP TIE FOR FORMING PANEL SYSTEMS filed Apr. 26, 2024. U.S. application Ser. No. 18/885,036 is a continuation of U.S. Non-Provisional application Ser. No. 18/093,622 filed Jan. 5, 2023, issued as U.S. Pat. No. 12,110,697 on Oct. 8, 2024, which is a continuation of U.S. Non-Provisional application Ser. No. 17/164,312 filed Feb. 1, 2021, issued as U.S. Pat. No. 11,572,701 on Feb. 7, 2023, which is a continuation of U.S. Non-Provisional application Ser. No. 16/252,281 filed Jan. 18, 2019, issued as U.S. Pat. No. 10,907,365 on Feb. 2, 2021, which claims priority to U.S. Provisional Application No. 62/619,545 filed Jan. 19, 2018, entitled LOOP TIE FOR CONCRETE FORMING PANEL SYSTEMS. The contents of the prior applications are incorporated by reference herein in their entirety.

### BACKGROUND OF THE INVENTION

Conventional concrete walls may be created by pouring concrete into a suitable concrete form. As is known in the art, concrete foundation walls are generally poured between two sets of concrete forms disposed in essentially parallel relationship and defining therebetween a channel having a dimension for the desired thickness of the concrete wall. Such opposed, spaced apart walls are generally held in a fixed relationship relative to each other against the immense weight of any poured concrete by tie-wires and turnbuckle assemblies having abutment surfaces against which a locking or latching arm on adjacent form sections abut. Once assembled into the shape of the wall, wet concrete is poured into the channel formed between the concrete forms and allowed to dry. The concrete forms typically comprise multiple form panels, which may for example be formed of wood, metal or any other suitable well-known material. The height of the form panel may vary by application.

Multiple form panels may be placed side-by-side in order to construct a wall of a desired length. Because the wet poured concrete takes the shape of the forms in which it is placed, the finished concrete wall corresponds in configuration to the assembled form. Therefore, it is important to align precisely the panels composing the concrete form in order to ensure that the finished wall has the desired appearance and strength.

The concrete forming systems can also employ tie-rods that are disposed between aligned panels in order to keep the panels properly spaced apart and to ensure that the panels are coupled to each other in a secure manner. The tie rods extend through openings formed in the spaced apart form panels and hold the sections against relative movement toward each other. The tie-rods may extend outwardly of the sections by a selected amount as is known in the art. The portion of the tie-rods that extend beyond the panel forms typically include a flattened or coined section that is adapted to engage with the latch that is coupled to the panel bar. Once the concrete is poured between the panel forms and allowed to cure, the portion of the tie rods that extend beyond the concrete walls can be snapped off.

Conventional tie rods are typically formed of metal, such as steel. However, the prior art has also designed systems that employ fiberglass ties in the shape of linear rods. The fiberglass tie rods are typically formed of fiberglass fibers that are all essentially disposed parallel to each other and hence extend in a longitudinal direction. The rods can be coupled to the concrete forms according to known techniques. According to a first known system and method, the fiberglass tie rods can have a thread formed thereon so as to accept a corresponding fastening nut. A drawback of these types of rods is that it is expensive to grind the threads into the finished rod, and the fastening nuts can be difficult to attach at times.

According to another known system and method, the fiberglass rod can be secured to the form panels using complex and expensive fastening hardware. The hardware can include a bearing plate, a tensioning nut, and a barrel and jaw assembly that employs a wedge shaped gripper to grip the exposed end of the tie rod. A drawback of this type of hardware is that it is expensive, labor intensive, prone to rusting, and over time can be difficult to use. Further, the hardware when removed typically needs to be cleaned and maintained in order to remove excess concrete therefrom.

Another form of non-metallic tie used a fiberglass strip similar in form to conventional metal flat ties. However, a drawback of ties of this type are that they are significantly lower in strength relative to conventional metal ties and leaves a larger exposed end in the face of the wall when the exposed portion of the tie is removed. Further, these types of ties have poor water sealing capabilities and make it difficult to user a water stopping element, such as round rubber washer.

### SUMMARY OF THE INVENTION

The present invention is directed to a tie rod, such as a loop tie rod, suitable for use with known concrete forming systems. The tie rod is constructed from a non-metal fiber, such as fiberglass, that is wound about a pair of opposed thimble elements. The resultant tie rod is as strong as metal tie rod without the drawbacks of conventional metal tie rods. The tie rod of the present invention has selected advantages over conventional metal tie rods. For example, the fiberglass tie rod creates a thermal break between the end portions of the tie rod. Also, non-metal fiber, such as fiberglass, has thermal expansion characteristics that are more closely matched with concrete, such that the concrete bonds better to the tie rod of the present invention. This prevents or significantly reduces water pathways that may develop between opposite wall surfaces of the concrete wall.

The tie rod of the present invention is suitable for use with concrete forming systems and include first and second thimble elements, a continuous fiber wound between the first and second thimble elements to form the tie rod, wherein each of the thimble elements has a main body having a channel formed in an outer surface of the main body, and wherein the fiberglass fiber is disposed within the channel when wound thereabout. The continuous fiber is wound to have a depth greater than the thimble in the direction perpendicular to a plane of the thimble. The fiber is wound about the thimble element a selected number of times ranging between about 8 times and about 35 times.

In embodiments, the thimbles do not include loop-restraining sidewalls extending from the groove.

The channel in the thimble elements has a width of between about 0.175 inches and about 0.22 inches and is preferably about 0.20 inches. The main body of the tie rod has a generally horse-shoe shape, which has ether an open or a closed end.

The continuous fiber of the present invention can be formed of fiberglass and can be optionally coated with a curing agent. The curing agent can comprise an epoxy resin material.

The present invention can also be directed to a method of forming a tie rod suitable for use with a concrete forming system. The method can include providing first and second thimble elements, wherein each of the thimble elements has a main body having a channel formed in an outer surface thereof. Each of the thimbles is disposed in a mold, each mold having spaced-apart opposing major inner surfaces in a plane of the thimble. A continuous fiber is wound between the first and second thimble elements through the spaced-apart opposing major inner surfaces of each mold such that the fiber is disposed within the channel of each thimble element to form an uncured tie rod, curing the uncured tie rod to form a cured tie rod, and placing the cured tie rod under tension for a selected period of time to form the tie rod. The mold is removed from the thimbles.

The step of curing the uncured tie rod comprises heating the uncured tie rod for a selected period of time. The step of heating can further comprise heating the uncured tie rod for between about 1 and about 2 hours, and at a temperature of between about 250° F. and about 300° F.

The present invention can also include the step of optionally coating the fiber with a curing agent. Optionally, the fiber is pre-coated with a curing agent prior to winding the fiber about the first and second thimbles.

The present invention can further include tensioning the cured tie rod in a carrier bar coupled to the mold.

The present invention can also be directed to a mold for manufacturing a tie rod having a thimble, wherein the thimble defines an opening therethrough and a plane of the thimble, the mold includes a first piece and a second piece. The first piece includes a first body portion and a first major inner surface configured to receive the thimble in the plane of the thimble. The first piece includes a first lock portion. The second piece includes a second body portion, a second major inner surface, and a second lock portion configured to mate with the first lock portion. The first and second pieces mate such that the first and second major inner surfaces are spaced apparat and parallel to the plane of the thimble. The thimble is disposed to receive a wound filament between the first and second major inner surfaces.

The mold can further include a clamp portion configured to fit over the first and second pieces when the first lock portion is mated with the second lock portion. The clamp portion can be configured to fit in a carrier bar to form a tensioning assembly. The first and second major inner surfaces each include concave edges configured to impart a rounded shape to the wound filament.

Those of ordinary skill in the art will recognize that the present invention contemplates and can include any combination of the foregoing features or elements.

### BRIEF DESCRIPTION OF THE DRAWINGS

These and other features and advantages of the present invention will be more fully understood by reference to the following detailed description in conjunction with the attached drawings in which like reference numerals refer to like elements throughout the different views. The drawings illustrate principals of the invention and, although not to scale, show relative dimensions.

FIG. 1 is a perspective view of a metal, frame based concrete forming system suitable for employing the tie rod of the present invention.

FIG. 2 is partial sectional view of adjacent concrete forming systems employing mounting hardware, such as wedge bolts, and the tie rod of the present invention.

FIG. 3 is a perspective view of the wedge bolt of FIG. 2.

FIG. 4 is a perspective view of the tie rod of the present invention.

FIGS. 5 and 6 are perspective views of the thimble portion of the tie rod of the present invention.

FIG. 7 is a cross-sectional view of the thimble portion of the tie rod of the present invention along line 7-7 of FIG. 6.

FIG. 8 is a cross-sectional view of the thimble portion of the tie rod of the present invention along line 8-8 of FIG. 6.

FIG. 9 is a perspective view of the thimble portion of the tie rod of the present invention illustrating the tab portion of the thimble.

FIG. 10 is a perspective view of the tie rod of the present invention.

FIG. 11 is a front view of another embodiment of the thimble element of the present invention.

FIG. 12 is a side view of the thimble element of FIG. 11.

FIG. 13A is a schematic block diagram illustrating the winding machine employed for winding the fiber to create the tie rod of the present invention.

FIG. 13B is a flowchart diagram illustrating the steps for forming the tie rod of the present invention.

FIG. 14 is a side view of another embodiment of the tie rod of the present invention.

FIG. 15A is a side view of a portion of the tie rod of FIG. 14.

FIG. 15B is a cross-sectional end view of the portion of the tie rod of FIG. 15A taken along lines 15-15 of FIG. 14.

FIG. 16 is an exploded view of a manufacturing mold and thimble for use in the process of FIG. 13B.

FIGS. 17A-17D are perspective views of the mold and thimble of FIG. 16 in various stages of installation.

FIG. 18A is a top view of the mold of FIG. 16.

FIG. 18B is a side view of the mold of FIG. 18A.

FIG. 18C is a cross-sectional end view of the mold of FIG. 18A taken along lines 18-18.

FIG. 19A is top view of tensioning assembly including a carrier bar and the mold of FIG. 16.

FIG. 19B is side view of the tensioning assembly of FIG. 19A.

FIG. 19C is a side view of the carrier bar of FIG. 19A.

FIG. 19D is an end view of the tensioning assembly of FIG. 19A.

### DETAILED DESCRIPTION OF THE INVENTION

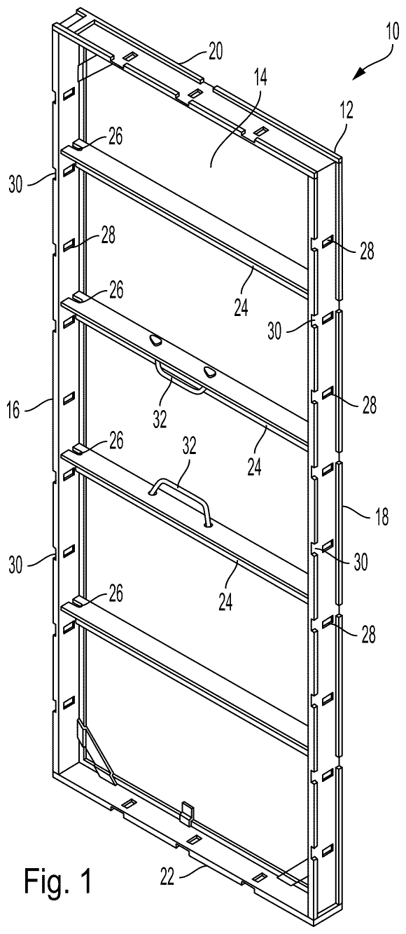

There exists in the art metal, frame-based, panel type concrete forming systems and associated hardware, such as fillers and wedge bolts, for forming concrete walls of any size and shape. An example of a commercially available metal concrete forming system is the Steel-Ply Concrete Forming System from Dayton Superior Corp. The illustrated metal concrete forming system 10 includes a steel frame 12 that can employ a metal or wood facing 14. As shown in FIGS. 1-3, the metal frame 12 has a pair of vertical side rails 16, 18 forming left and right-side rails and a pair of horizontal side rails 20, 22 forming the top and bottom rails. Further, a plurality of horizontal cross-member or support rails 24 are formed between the two opposed side rails 16, 18 and help form supports for the frame 12. The cross members 24 also have a cross-member slot 26 formed therein adjacent to the side rails 16, 18. The facing material 14, such as plywood, is attached to one face side of the frame 12. The plywood 14 is typically used to form a smooth finish to the formed concrete wall. The vertical side rails 16, 18 both have side slots 28 formed therein intermittently throughout the length of the side rail. The side slots 28 are adapted to accommodate a securing bolt, such as a wedge bolt, as described further below. Further, the side rails 16, 18 include a plurality of dado slots 30 formed therein adjacent to the side slots 28. Further, certain cross-members 24 can include a handle 32 formed thereon to assist the user in lifting and manipulating the panel.

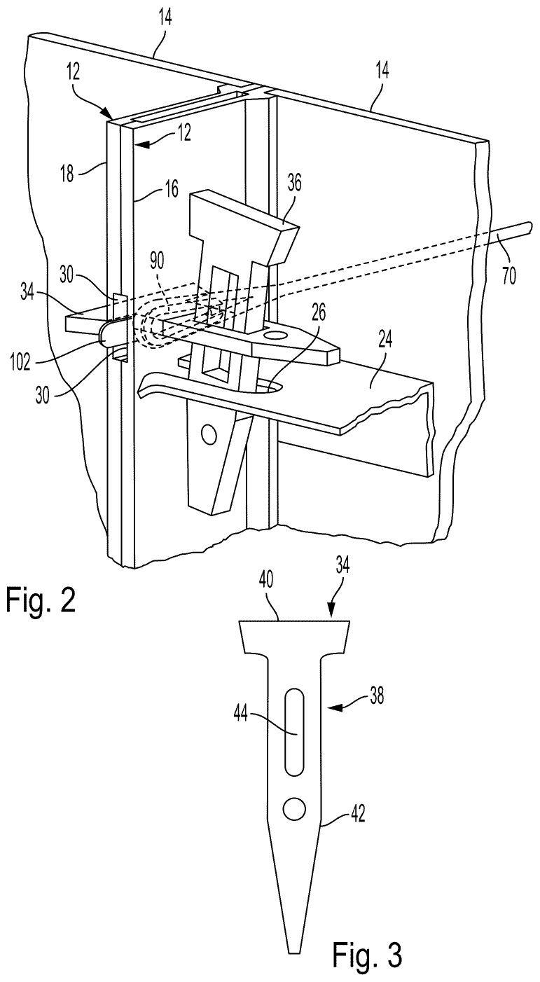

The metal form panels 12 can be placed adjacent to each other to form the rough outline of the concrete wall to be formed. As shown in FIGS. 2-3, the adjacent panels 12 can be coupled together and to tie rods or ties 70 disposed within the wall to be formed using a lock-bolt set comprising first and second wedge bolts 34, 36, as is known in the art. In the current embodiment and example, the metal framing system employs loop style tie rods or ties. The first and second wedge bolts can be identical if no filler parts are employed or can be differently configured if a filler part is employed, as is known. As shown, each of the wedge bolts 34, 36 has a main body 38 having a head portion 40 and a wedge-shaped body 42 extending therefrom. The wedge-shaped body 42 has a bolt slot 44 formed therein.

The dado slots 30, 30 formed in the side rails 18, 16 of adjacent panels form an enclosure that is adapted to accommodate the protruding end of an associated tie rod 70. The tie rod 70 is used to help strengthen the finished wall that is formed. In metal concrete forming systems, the tie rod can be either a loop tie or a flat tic. Conventional metal loop ties have a main body that has a loop formed at both ends. These types of ties can also be conventionally referred to as panel or S-ties. When positioned correctly between opposed forming panels, the loop ends of the tie are positioned between the dado slots 30 and is aligned with the side slots 28 formed in the side rails 16, 18. The first wedge bolt 34, such as a connecting wedge bolt, is slid into the side slot 28 formed in the side rail 16, 18 and through the loop end of the tic. As such, the tapered end of the first wedge bolt 34 and specifically the bolt slot 44 is exposed. The tapered end 42 of the second wedge bolt 36, such as a clamping wedge bolt, is disposed in the bolt slot 44 and also seats within the cross-member slot 26. The clamping bolt helps connect together the adjacent panels and also helps secure the tie rod.

The tie rod 70 is typically disposed between aligned panels in order to keep the panels properly spaced apart and to ensure that the panels are coupled to each other in a secure manner. The tie rod 70 extends through openings formed in the spaced apart form sections or panels and holds the sections against relative movement toward each other. The tie rods may extend outwardly of the concrete walls and if desired the form panels by a selected amount as is known in the art. Once the concrete is poured between the panel forms and allowed to cure, the portion of the tie rods that extend beyond the concrete walls can be removed.

A problem with conventional tie rods is that they can be relatively difficult to position relative to the metal form panels. Further, the portion of the tie rods that extends beyond the formed and cured concrete wall can be difficult to remove, or when snapped off, typically do not break off cleanly from the rest of the tie rod embedded in the wall. Further, in architectural environments where a clean and relatively unmarked wall is important, the use of conventional metal loop or flat ties presents a problem. Currently, the portion of the ties that extend beyond the wall are snapped off or otherwise removed. This removal process may serve to mar the formed concrete wall. Also, the portion of the tie that remains in the wall can be prone to rusting, and hence at a later time can mar the aesthetics of the finished wall. Further, the ties cannot be used in selected applications, such as sites that require non-magnetic features in the walls, such as medical buildings.

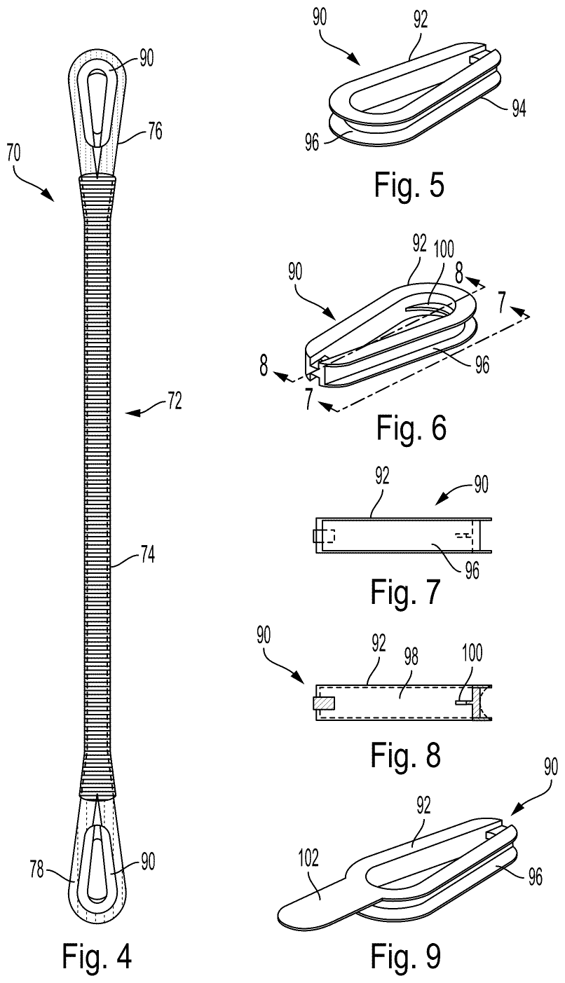

To address these and other issues of conventional metal loop ties, the tie rod 70 of the present invention can be formed of a material other than metal. According to one practice, the tie rod is non-metal, and can be made for example from fibers formed of fiberglass, carbon, and para-aramid synthetic fibers such as Kevlar. The material can be coated, if desired, with one or more other materials. For example, the fiber material can be pre-coated, coated as the fiber is wound about the thimble elements 90, or coated after the tie rod is formed using any suitable material. The coating material can be used to bind the fiber winds together or can be used as a curing or hardening agent. The tie rod 70 of the present invention is illustrated in FIGS. 4-9. The tie rod of illustrated therein is a loop style tie rod, although other forms and configurations can be employed consistent with the teachings of the present invention. The illustrated loop tie rod 70 of the present invention has a main body 72 with a central linear region 74 and has loops 76, 78 formed at opposed ends. The loops 76, 78 can be sized, if desired, to house a reinforcing element, such as thimble element 90. According to an alternate embodiment, the illustrated loop tie rod 70 does not include the thimble clement 90. The loop tie rod 70 is preferably formed from a fiberglass material that can be, if desired, coated with a select material, such as a binding material. According to one embodiment, the fiberglass can be pre-coated or coated with any suitable curing or hardening material, such as with an epoxy resin material, such as that commercially available from TCR Composites, USA. The fiberglass is preferably a high strength glass fiber, although other strength types can be used. The fiberglass tie rod of the present invention has low thermal conductivity, and has a thermal expansion coefficient similar to concrete, thus creating a better bond between the tie and concrete, which serves to improve the overall water sealing capability of the tie. The fibers employed in the present invention, such as the fiberglass fibers, exhibit a tensile strength of between about 300K PSI and about 530K PSI. The finished and cured tie rod 70 preferably exhibits a tensile strength of around 6000 PSI. A key feature of the present invention is that the strength of the resultant fiberglass tie rod 70, in use, is able to significantly match the strength of conventional metal loop ties.

The illustrated thimble element 90 has a main body 92 that is shaped in a manner similar to a horse-shoe shape that can have an open or closed end, and preferably has a closed end. The outer circumferential edge or surface 94 of the main body has a channel 96 formed therein. The channel preferably has a thickness or width of between about 0.175 inches and about 0.22 inches, and preferably has a width of about 0.20 inches. The inner surface 98 of the main body has an optional raised edge-like protrusion 100 that forms a fin feature or element. In an alternate embodiment, as shown in FIG. 9, the thimble 90 can include a tab-like protrusion 102 that extends outwardly from the outer surface 94 of the main body 92. The tab portion can function as a side wall of the main body for the thimble element 90 that can help guide the fiber 114 into the channel or groove 96. According to another practice, the floor of the channel 96 can have a low friction coating or material applied thereto. For example, the channel can be coated with a polytetrafluoroethylene (PTFE) material or with a polytetrafluoroethylene (PTFE) tape so as to reduce the frictional forces of the thimble 90. Further, the coating also serves to increase the overall strength of the tie rod 70. Alternatively, the thimble main body can be coated with any suitable material, such as with a tin-based material or PTFE. The thimble element 90 of the present invention can be made from any suitable material, including from metal materials, such as from zinc-based alloys (e.g., Zamak 3), steel, aluminum, magnesium alloy, carbon fiber, polytetrafluoroethylene (PTFE), or plastic, or from combinations of these materials.

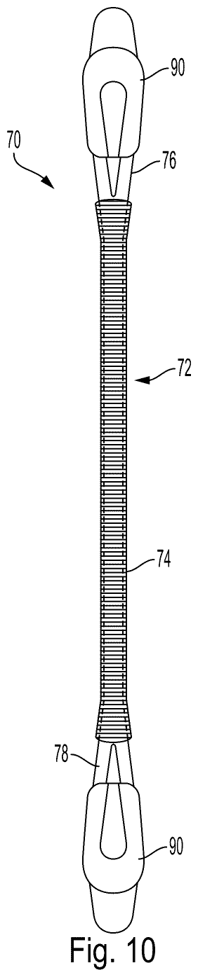

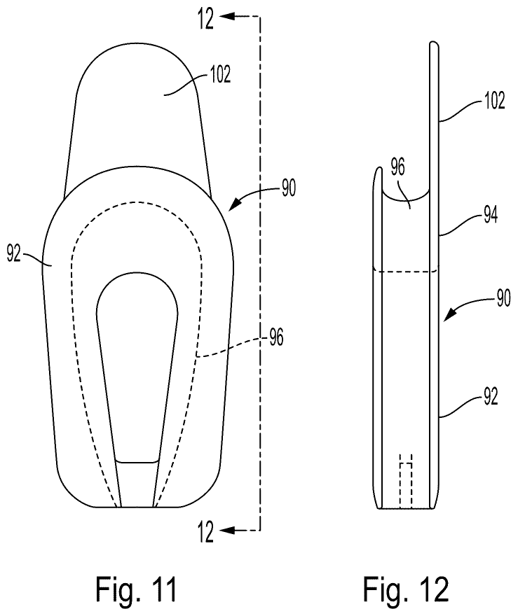

The illustrated loop tie rod 70 of the present invention can be formed by winding the fiber 114 (e.g., fiberglass material) using any suitable fiber or filament winding machine 110 about the opposed thimble elements 90. For example, as shown in FIGS. 10A and 10B, the loop tie rod 70 has associated therewith the thimble elements 90, 90. The illustrated fiber 114 can be wound about the thimble elements 90, 90 by the winding machine according to known techniques, step 120. For example, the tie rod 70 can be placed on or coupled to a rotating and/or translational mandrel or support (not shown) and the fiber can be wound, under tension, between the opposed thimble elements. Alternatively, the fiber winding machine 110 can be rotated about the tie rod. The loop tie rod 70 thus includes one or more continuous glass fibers that are wound into the desired shape of the loop tie. When the continuous fiber is wound about the thimbles 90, 90, the fibers are preferably maintained under tension, such as between about 2 lbs and about 10 lbs pressure, and the overwrap tension on the fiber when wound to create the overwrap is between about 5 lbs pressure and about 20 lbs pressure. The fiber is wound about the thimble elements a selected number of times ranging between about 8 times and about 35 times, depending upon the size and yield of the fiber. The fibers are wound between the thimbles until the channel 96 is filled with the fibers. Upon completion, the tie rod can be completed by optionally continuing to wind the fiber to create an optional overwrap in the central region 74 of the tie. As is shown, the number of wraps of the fiber between the thimble elements 90, 90 can be specified such that the fiber fills the channel 96 of the thimble element without extending beyond the confines of the channel. Optionally, the fiber can be wound further until the fiber extends past the confines of the channel 96, as shown in FIG. 4.

The completed loop tie 70 is then removed from the supporting structure, step 122, and then cured by heating by placing the loop tie in any suitable heating device for a selected duration of time and at a selected temperature, step 124. For example, according to one embodiment, the loop tie is cured by being placed in a heating oven for about 1 to about 2 hours, at a temperature of about 250° F. to about 300° F., based on the type of material used. Those of ordinary skill will readily recognize that the time and temperature can vary as a function of the material type used to form the tie. Those of ordinary skill will also recognize that UV-based epoxy resins can also be used, and hence can be cured using UV radiation rather than heat. Once completed, the finished tie can be placed on a tensioning device or frame (not shown) which keeps the cured loop tie under tension so as to align and equalize the fibers for any suitable amount of time, step 126.

The illustrated tab portion 102 of the thimble 90 can help guide the tie rod 70 through the dado slots 30 formed in the form panels 12 when the panels are assembled. Further, the tab portion 102 can provide a visual indication or confirmation that a tie rod 70 is indeed in place when the panels are all assembled, since it projects outwardly beyond the panels on the outside of the wall. Without the tab portion, there is no quick and easy way to visually confirm that a tie rod was not missed when installing the panel forms. Those of ordinary skill will readily recognize that not all types of ties, including loop ties, are designed to provide an end portion that will readily pass through the panel forms and extend therebeyond to allow visual confirmation of placement. Thus, the tab extension 102 allows the fiberglass tie rod of the present invention to easily pass through the forms (e.g., the dado slots) and extend past the forms so as to easily viewable by the user.

Further, the optional ridge or fin element 100 formed along the inner surface 98 of the main body 92 is adapted to bear against the wedge bolt 34, 36 that engages it when assembled in the panel system. The fin element 100 is sized and shaped such that it can deform, that is, give way under load, in a predictable way and rate. In doing so, the fin element 100 allows the tie rod 70 to effectively lengthen to a limited extent, which aids in equalizing the load shared with neighboring tie rods, so that slight variations in length of the tie rods do not subject the shortest tie rod in a group to unwanted and undesirable stresses. Further, the ridge portion is a visual indicator and can act as forensic evidence of overloading of the tie rod ends of the tie in the event of a blowout of the wall when pouring. Similarly, the thimble element 90 can be free of the fin element 100 and the main body portion of the thimble element that contacts the wedge bolts or other panel elements can deform at the point of contact, which is usually where the inner portion of the thimble element contacts the wedge bolts in an axial direction. This deformation of the tie rod main body also serves to effectively lengthen the overall length of the tie rod to a limited extent. Further, the tie rod of the present invention can be configured to work with plywood form panel systems, such as Resi-Ply concrete forming systems, and aluminum form panel systems.

According to another embodiment, the present invention relates to a tie rod or tensile joining member for temporarily joining together opposing panels 14 used in forming concrete structures. Because of typically high tensile loads, conventional ties rods are usually made of medium carbon steel or stainless steel, work-hardened by rolling or drawing to achieve a high tensile strength (e.g., typically a minimum 120,000 psi tensile strength). The liquid concrete is poured into the space between the opposing form panels 14. After it has hardened to a sufficient strength, the form panels 14 are removed and exposed portions of the tie rods are broken off by flexing, generally at a point close to the surface of the concrete. The rest of the tie rod remains permanently embedded within the concrete structure.

The tie rods of the present invention are used with a particular widely-used concrete form panel, known simply as-aluminum forms, with functionally equivalent panels being made by a number of manufacturers. The conventional aluminum form panels all use a flat tie rod that is stamped from sheet steel with a finished cross section of about 0.078″ thick by about 1.5″ wide. The tie rods fit into a recess between adjacent form panels that is about 0.150″ wide by about 1.6″ high and connect to the form panels with a reusable round steel pin that is inserted into a corresponding hole near each end of the tie rod.

There are selected applications where it is desirable to use the non-metallic tie rod of the present invention with the aluminum form panels. Some of the applications can include where there are concerns about corrosion of the remnant conventional steel tie rod left in the concrete wall, where ferrous materials left in the wall can interact with magnetic fields, such as in MRI facilities or near induction furnaces, where a requirement exists that the broken remnant of the tie be at a greater depth from the surface, where there is a cosmetic requirement for the surface of the concrete, such that broken remnants of the tie rods, or the cementitious patching over of those remnants, creates a visual flaw or would be prone to staining from corrosion, where the embedded remnants of the conventional steel tie rods would provide an undesirable electrical conduction path through the wall, such as in the case of utility electrical vaults, and where the embedded remnants of the conventional steel toe rods would provide an undesirable thermal conduction path through the wall, particularly when insulating foam is embedded within, or applied to the surface of a concrete wall.

In such or similar cases, the tie rod 70 of the present invention, made of a composite material such as glass-epoxy, can meet these requirements. Such composite form tie rod solutions exist for many other types of form systems, but the narrow opening for the tie rods in the aluminum form panels, along with the high tensile strength requirement for the tie rods used with such forms, has precluded the use of those composite form ties with aluminum form panels.

The present invention meets the requirements of a tie rod for aluminum form panels by being constructed in the form of a loop-ended tie rod or bar using continuous high-strength, non-metallic fibers (e.g., glass or carbon) that are wound around metallic thimble elements 90 formed on each end. The thimble elements 90 spread the load from the 0.625″ diameter form pin and, due to their special design, enable the finished tie rod 70 to carry a higher load. Because of the structural constraint that the tie rod fit into the narrow tie recess located between the form panels, an important aspect of the present invention is that the glass-epoxy filament or fiber 114 is wound onto the thimble elements 90 and into the groove 96 without the main body of the thimble element 90 employing any restraining side walls, since the sidewalls would take away valuable cross-sectional area from the composite filament. In order to wind the fiber or filament 114 around the sidewall-less thimble elements 90, and have the finished part meet the requirement of being thin enough to fit the form panels 14, the tie rods of the present invention are wound using a removable and reusable mold assembly that is attached to the thimble elements during fiber winding and remains in place during the oven or other curing process of the part, and then eventually removed. To maintain the shape of the mold assembly against the deforming pressure of the wound filament 114, an additional clamp element can be temporarily attached to the thimble mold assembly during curing.

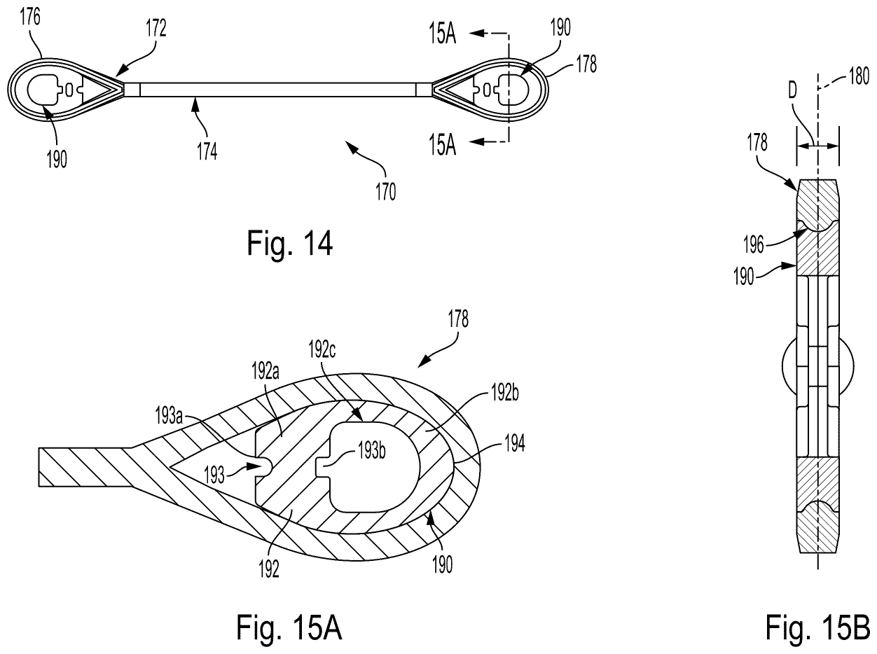

FIG. 14 illustrates tie rod 170, which is another embodiment of loop tie rod 70. The loop tie rod 170 of the present invention has a main body 172 with a central linear region 174 and has loops 176, 178 formed at opposed ends. The loops 176, 178 can be sized, if desired, to house a reinforcing element, such as thimble element 190. The loop tie rod 170 is preferably formed from a fiberglass material that can be, if desired, coated with a select material, such as a binding material. According to one embodiment, the fiberglass can be pre-coated or coated with any suitable curing or hardening material, such as with an epoxy resin material. The fiberglass is preferably a high strength glass fiber, although other strength types can be used. The fiberglass tie rod 170 has low thermal conductivity, and has a thermal expansion coefficient similar to concrete, thus creating a better bond between the tie and concrete, which serves to improve the overall water sealing capability of the tic. The fibers, such as the fiberglass fibers, exhibit a tensile strength of between about 300K PSI and about 530K PSI. The finished and cured tie rod 170 preferably exhibits a tensile strength of around 6000 PSI.

FIGS. 15A and 15B illustrate the thimble 190. FIG. 15A is a side view of an end of the loop tie rod 170 in the plane of the thimble 190. FIG. 15B is a cross-sectional end view of the loop tie rod 170 taken along lines 15-15 of FIG. 14 that illustrates the plane of the thimble, or thimble plane 180. The thimble clement 190 has a main body 192 that is shaped in a manner similar to a horse-shoe shape that can have an open or closed end, and preferably has a closed end as in the illustrated embodiment. In the illustrated embodiment, the main body 192 includes a base portion 192a, a curvilinear portion 192b, and defines an opening 192c. As illustrated in FIG. 15A, the curvilinear portion 192b in one embodiment is shaped to include an elliptical profile in regions engaging with the fibers of the tie rod for strength. The base portion includes a notch 193, such as a pair of notches 193a, 193b formed along the axis of the tie rod. As illustrated in FIG. 15B, the outer circumferential edge or surface 194 of the main body has a channel 196 formed therein. The channel 196 is a groove into which the wound filament of loop 178 is seated (and loop 176 on the other end). As distinguished from an embodiment of thimble illustrated in FIGS. 4 and 10, the thimble 190 does not include loop-restraining sidewalls extending from the groove. In particular, the, the thimble 190 does not include loop-restraining sidewalls that extend past the widest portions of the loop filament and increase the depth or thickness, as defined in dimension D of FIG. 15B, past the thickness of the loop 178. The dimension D is in a direction perpendicular to the thimble plane 180. The continuous fiber is wound to have a depth at least as much as the depth of the thimble in the direction perpendicular to a plane of the thimble. In other words, the thickness of the thimble 190 is not greater than the thickness of the loop 178 in the illustrated embodiment. In some embodiments, the continuous fiber is wound to have a depth greater than the depth of the thimble in the direction perpendicular to a plane of the thimble. In some embodiments, the channel 196 includes a low friction coating or material applied to the channel 196 similar to thimble 90. The thimble 190 can be made from any suitable material and similar to thimble 90. In one embodiment, the thimble 190 is a die-cast zinc.

The inclusion of a thimble into the tie rod provides several advantages including an element to distribute the load placed on the loop from the pins or anchors, and the use of thimbles allows for a finished tie rod to carry a larger load than without a thimble. The lack of sidewalls on thimble 190 presents several advantages in a finished loop tie rod 170, including advantages related to the thinner shape. the lack of loop-restraining sidewalls in thimble 190 allow the tie rod to fit between narrow recesses of the form panels or allow for larger loops 176, 178 or filament area within the same cross-sectional area of the end of the tie rod 170, so that the tie rod 170 is stronger, thinner, or a combination of both over tie rods having loop-restraining sidewalls. The lack of loop-restraining sidewalls, however, presents a manufacturing challenge in winding the filaments over the thimble, which tend to fall off during winding or curing leading to poor yields and increased costs.

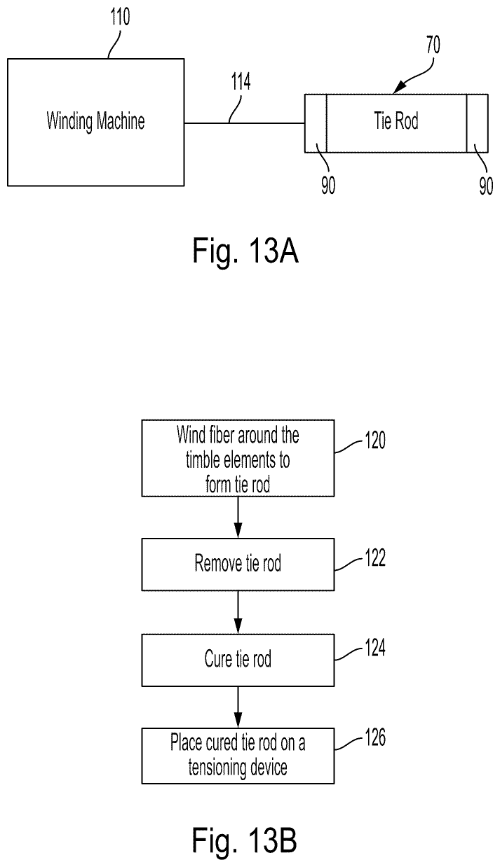

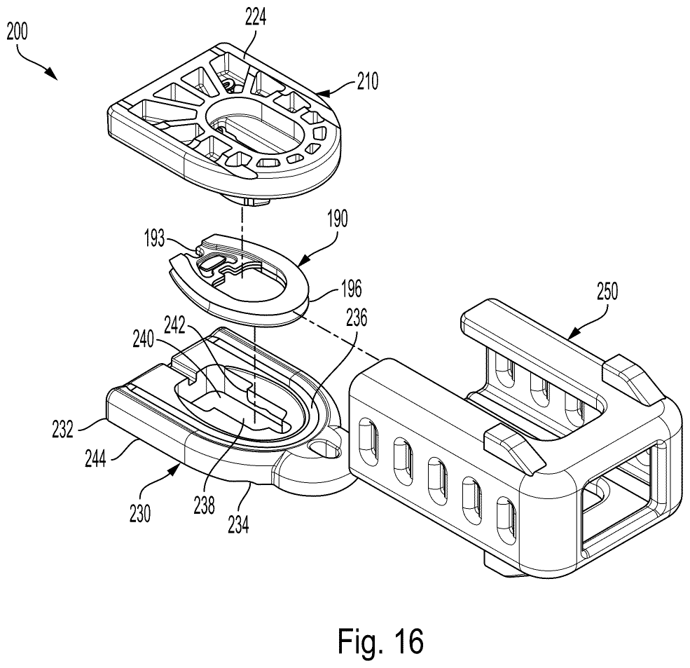

FIG. 16 illustrates an embodiment of a mold assembly 200 suitable for use with the thimble 190 to facilitate manufacturing the tie rod without loop-restraining sidewalls on the embodiment of the thimble 190. The mold assembly 200 includes a first mold piece or element 210 and a second mold piece or element 230 that are configured to mate together over the thimble 190 and permit winding of the filament over the thimble to restrain the loops as they are being wound in the groove 196, and a clamp element 250 configured to fit over the mated first and second mold pieces 210, 230 during curing of the tie rod. The mold assembly 200 can be applied in the process illustrated in FIG. 13B such as using the winding machine of FIG. 13A. For example, the first and second mold pieces 210, 230 can be applied over the thimble element 190 while the fibers are wound around the thimble to form the tie rod 120. In some embodiments, the clamp element 250 is fit or seated over the mated first and second mold pieces 210, 230, with the wound thimble in place, during curing 124 and tensioning 126. According to one embodiment, the mold assembly 200 can be removed after manufacturing to yield or form the finished tie rod 170. The mold assembly 200 can be reusable. The mold assembly 200 presents a cost effective and easy to use device to increase manufacturing yields of tie rods without loop-restraining sidewalls.

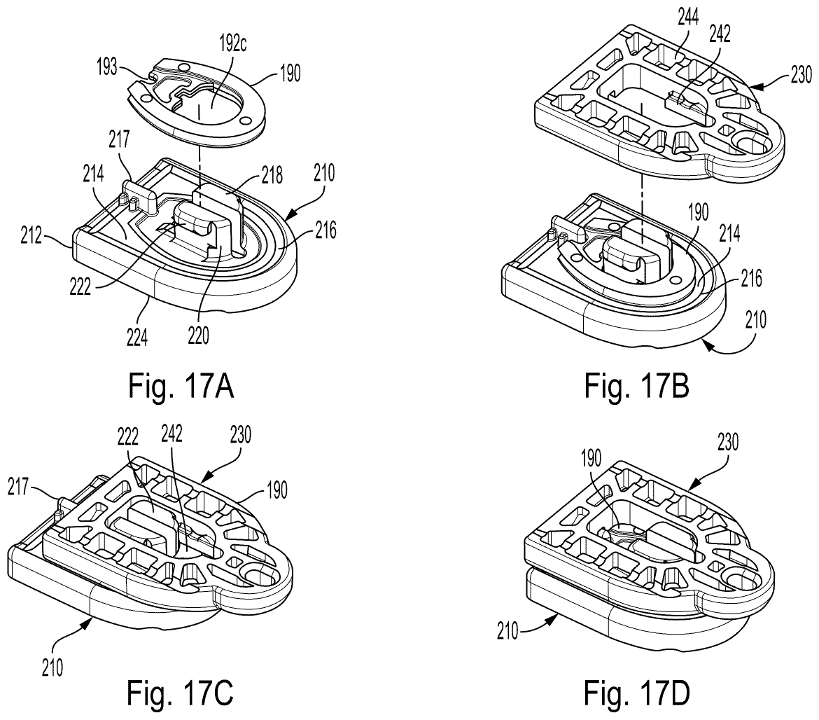

FIGS. 17A-17D illustrate a method of installing and using the mold assembly 200 for use in the manufacture of the tie rod 170. FIG. 17A illustrates the thimble 190 being placed on the first mold piece 210. FIG. 17B illustrates the second mold piece 230 being brought over the first mold piece 210 with the thimble 190 therebetween. FIG. 17C-17D illustrate the first and second mold pieces 210, 230 locked together with the thimble 190 therebetween such that the first and second mold pieces 210, 230 are spaced apart around the channel 196 of the thimble to allow the filaments to be wound in the channel 196.

As shown in FIG. 17A, the first mold piece 210 can include a body portion 212 having a major inner surface 214 configured to receive the thimble 190 and parallel to the plane of the thimble 180, the major surface 214 at least partially surrounded by concave edge 216 that are configured to impart a rounded shape to the wound filament. The body portion 212 includes a tab 217 protruding from the major inner surface 214 configured to mate with a notch 193 on the thimble 190 to hold the thimble 190 in place relative to the mold 200. The body portion 212 includes a lock portion 218, which is configured to extend through the thimble opening 192c when the thimble is positioned on the major inner surface 214 and mated with the notch 193. The lock portion 218 on the first piece 210 includes a pair of protrusions 220 extending from the major inner surface 214 in a direction perpendicular to the thimble plane 180 and including shoulders 222. The body portion 212 also includes an outer portion 224 opposite the inner surface 214.

With reference to FIG. 16, the second mold piece 230 includes a body portion 232 having a major inner surface 234 configured to receive the thimble 190 and parallel to the plane of the thimble 180, the major surface 234 at least partially surrounded by concave edges 236 that are configured to impart a rounded shape to the wound filament. The body portion 232 includes a lock portion 238, which is configured to be within the thimble opening 192c when the thimble is positioned on the major inner surface 234. For example, the lock portion 238 defines a lock opening 240 to receive a mating portion of the first piece 210, and a set of rails 242 to slidably engage with the mating portion of the first piece. The body portion 232 also includes an outer portion 244 opposite the inner surface 234.

FIG. 17A illustrates when the thimble 190 is placed on the first mold piece 210. The lock portion 218 of the first mold piece 210 is placed through the opening 192 of the thimble 190 and the tab 217 is fit into the notch to hold the thimble 190 in place on the major inner surface 214. The concave edge 216 surrounds the thimble 190. FIGS. 17B and 17C illustrate the lock opening 240 of the second piece fit over the pair of protrusions 220 of the first piece at the widest part of the lock opening 240. The first and second mold pieces 210, 230 are moved with respect to one another in the thimble plane 180 such that the shoulders 222 slidably engage with the rails 242 and lock the first piece 240 to the second mold piece 230 as illustrated in FIG. 17D. While locked together, the major inner surface 214 of the first mold piece 210 and the major inner surface 234 of the second piece are spaced apart from each other so as to allow the filament to be wound over the thimble 190. The first and second major inner surfaces 212, 232 are spaced apparat and parallel to the plane of the thimble 180, wherein the thimble 190 is disposed to receive a wound filament between the first and second major inner surfaces 212, 232.

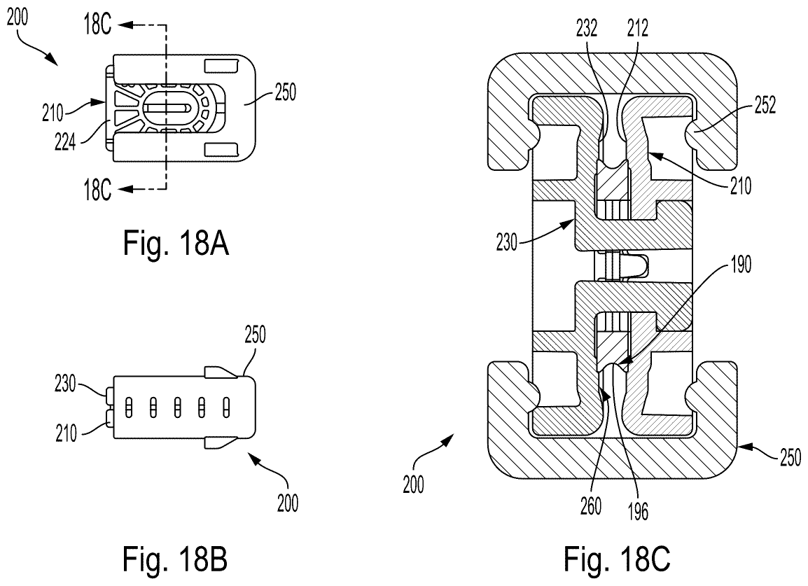

FIGS. 18A-18C illustrate the clamp 250 slidable disposed over the interlocked first and second mold pieces 210, 230 of the mold 200. The clamp 250 is configured to fit over the first and second mold pieces 210, 230 when the first lock portion 218 is mated with the second lock portion 238. For example, FIG. 18C illustrates a cross sectioned view of the mold assembly 200 taken along lines 18-18 in FIG. 18A. FIG. 18C illustrates the interlocked first and second pieces 210, 230 with the thimble 190 therebetween taken from lines 18-18 of FIG. 18A. The interlocked first and second pieces 210, 230 define a space 260 exposing the groove 196 of the thimble 190 to allow the filament to be wound on the groove 196 while the mold assembly 200, particularly the major inner surfaces 214, 234 retain the filament on the groove 196 during manufacture. The clamp 250 is attached to the first and second mold pieces 210, 230 with the filament in place during curing. The embodiment of the clamp 250 is illustrated to include a protuberance 252 to engage with the body portions 212, 232 of the first and second mold pieces 210, 230.

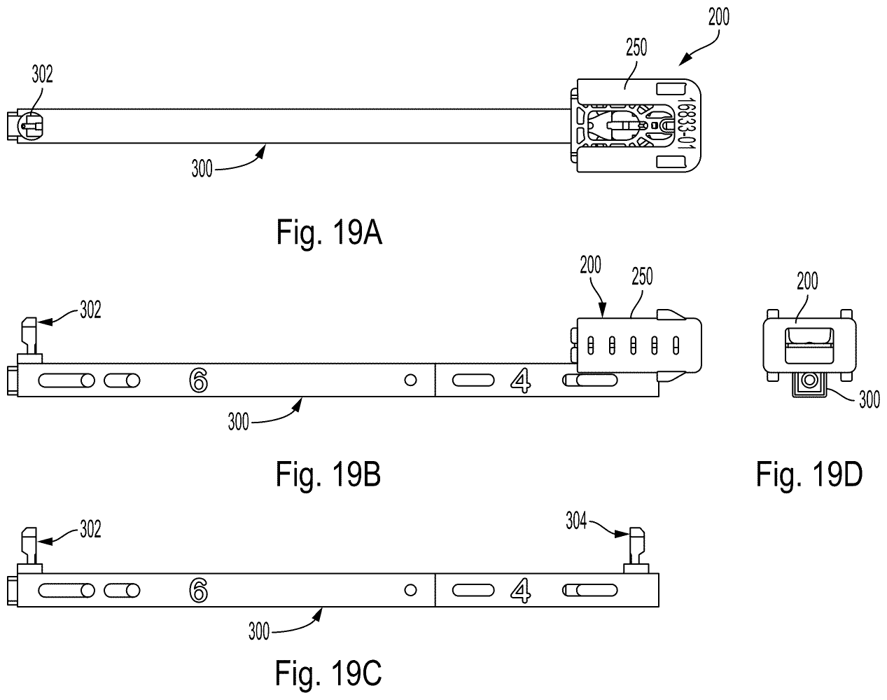

FIGS. 19A-19D illustrate the mold assembly 200 used in combination with a carrier bar 300 as a tensioning assembly in FIG. 13B for curing 124 and tensioning 126. The mold assembly 200 including the tie rod and the thimble, are placed on the carrier bar 300, which maintains the tie rod under tension so as to align and equalize the fibers. The carrier bar 300 includes a fixed post 302 attachable to the fibers and a spring loaded post 304 attachable to the mold assembly 200 across a spring-loaded stretcher, in one embodiment, or vice versa (the wound tie is not illustrated). The mold assembly 200 with the clamp 250 is urged away from the fixed post 302 to provide the tension via the internal spring. The carrier bar can be used in an oven to cure the ties and then removed from the oven and stored to maintain tension.

The foregoing description may provide illustration and description of various embodiments of the invention but is not intended to be exhaustive or to limit the invention to the precise form disclosed. Modifications and variations of the tie rod of the present invention may be possible in light of the above teachings or may be acquired from practice of the invention.

For example, while a series of acts has been described above, the order of the acts may be modified in other implementations consistent with the principles of the invention. Further, non-dependent acts may be performed in parallel.

In addition, one or more implementations consistent with principles of the invention may be implemented using one or more devices and/or configurations other than those illustrated in the Figures and described in the Specification without departing from the spirit of the invention. One or more devices and/or components may be added and/or removed from the implementations of the figures depending on specific deployments and/or applications. Also, one or more disclosed implementations may not be limited to a specific combination of hardware. Furthermore, certain portions of the invention may be implemented as logic that may perform one or more functions. This logic may include hardware, such as hardwired logic, an application-specific integrated circuit, a field programmable gate array, a microprocessor, software, or a combination of hardware and software.

No element, act, or instruction used in the description of the invention should be construed critical or essential to the invention unless explicitly described as such. Also, as used herein, the article “a” is intended to include one or more items. Where only one item is intended, the term “a single” or similar language is used. Further, the phrase “based on,” as used herein is intended to mean “based, at least in part, on” unless explicitly stated otherwise. In addition, the term “user”, as used herein, is intended to be broadly interpreted to include, for example, an electronic device (e.g., a workstation) or a user of an electronic device, unless otherwise stated.

Further, the invention can be employed using any combination of features or elements as described above and are not limited to the current recited steps or features.

It is intended that the invention is not limited to the particular embodiments disclosed above, but that the invention will include any and all particular embodiments and equivalents falling within the scope of the following appended claims.

1. A tie rod suitable for use with a concrete forming system, comprising
first and second thimbles,
a continuous fiber wound between the first and second thimbles to form the tie rod,
wherein each of the thimbles has a main body having a channel formed in an outer surface of the main body, and wherein the continuous fiber is disposed within the channel when wound thereabout, and wherein the continuous fiber is wound to have a depth greater than the thimble in the direction perpendicular to a plane of the thimble.

2. The tie rod of claim 1, wherein the main body of each thimble includes a base portion and a curvilinear portion that defines an opening.

3. The tie rod of claim 2, wherein the curvilinear portion is horseshoe shaped.

4. The tie rod of claim 2, wherein the curvilinear portion includes a elliptical profile.

5. The tie rod of claim 2, wherein the base portion includes a notch.

6. The tie rod of claim 1, wherein the thimbles do not include loop-restraining sidewalls extending from the groove.

7. The tie rod of claim 1, wherein the fiber is wound about the thimble elements a selected number of times ranging between about 8 times and about 35 times.

8. The tie rod of claim 1, wherein the fiber is formed of fiberglass.

9. The tie rod of claim 8, wherein the fiberglass fiber is coated with a curing agent.

10. The tie rod of claim 9, wherein the curing agent comprises an epoxy resin material.

11. A method of forming a tie rod suitable for use with a concrete forming system, comprising
providing first and second thimbles, wherein each of the thimbles has a main body having a channel formed in an outer surface thereof, wherein the thimbles do not include loop-restraining sidewalls extending from the groove,
disposing each of the thimbles in a mold assembly having a first mold element and a second mold element, wherein each of the first and second mold elements have spaced-apart opposing major inner surfaces in a plane of the thimble,
winding a continuous fiber between the first and second thimble through the spaced-apart opposing major inner surfaces of each of the first and second mold elements such that the fiber is disposed within the channel of each thimble element to form an uncured tie rod,
curing the uncured tie rod to form a cured tie rod,
placing the cured tie rod under tension for a selected period of time to form the tie rod. And
removing the mold from the thimbles.

12. The method of claim 11, wherein the step of curing the uncured tie rod comprises heating the uncured tie rod for a selected period of time within the mold.

13. The method of claim 12, wherein the step of heating further comprises heating the uncured tie rod for between about 1 and about 2 hours, and at a temperature of between about 250° F. and about 300° F.

14. The method of claim 11, wherein the step of curing includes exposing the tie rod to UV radiation.

15. The method of claim 11, further comprising the step of coating the fiber with a curing agent.

16. The method of claim 11, and further comprising tensioning the cured tie rod in a carrier bar coupled to the mold.

17. A mold assembly for manufacturing a tie rod having a thimble, wherein the thimble defines an opening therethrough and a plane of the thimble, the mold comprising:
a first mold piece having a first body portion and a first major inner surface configured to receive the thimble in the plane of the thimble, the first mold piece having a first lock portion,
a second mold piece having a second body portion, a second major inner surface, and a second lock portion configured to mate with the first lock portion, such that the first and second major inner surfaces are spaced apparat and parallel to the plane of the thimble, wherein the thimble is disposed to receive a wound filament between the first and second major inner surfaces.

18. The mold assembly of claim 17, further comprising a clamp portion configured to fit over the first and second mold pieces when the first lock portion is mated with the second lock portion.

19. The mold assembly of claim 18, wherein the clamp portion is configured to fit in a carrier bar to form a tensioning assembly.

20. The mold assembly of claim 17, wherein the first and second major inner surfaces each include concave edges configured to impart a rounded shape to the wound filament.
